(19) United States
(12) Patent Application Publication
(10) Pub. No.: US 2026/0277955 A1
(43) Pub. Date: Sep. 17, 2026

(54) INFORMATION PROCESSING SYSTEM, INFORMATION PROCESSING METHOD, AND RECORDING MEDIUM

(71) Applicant: NEC Corporation, Tokyo (JP)

(72) Inventors: Mamoru SAITA, Tokyo (JP); Hirofumi UEDA, Tokyo (JP); Norio YAMAGAKI, Tokyo (JP); Shunichi KINOSHITA, Tokyo (JP)

(73) Assignee: NEC Corporation, Tokyo (JP)

(21) Appl. No.: 19/553,590

(22) Filed: Mar. 2, 2026

(30) Foreign Application Priority Data
Mar. 13, 2025 (JP) 2025-040060

(51) Int. Cl. G06F 16/3329; G06F 21/57

(52) U.S. Cl. CPC G06F 16/33295; G06F 21/577

(57) ABSTRACT

An information processing system includes, at least one memory storing instructions, and at least one processor configured to execute the instructions to, extract a keyword related to a vulnerability of an object system included in an input sentence, specify a vulnerability identifier that specifies the vulnerability related to the keyword, specify a vulnerability specification word included in a vulnerability word dictionary in association with the vulnerability identifier, and generate instruction information including the input sentence, the vulnerability specification word, and an instruction sentence instructing generation of explanation information regarding the vulnerability related to the input sentence based on the vulnerability specification word.

### CROSS-REFERENCE TO RELATED APPLICATIONS

This application is based upon and claims the benefit of priority from Japanese Patent Application No. 2025-040060, filed on Mar. 13, 2025, the disclosure of which is incorporated herein in its entirety by reference.

### TECHNICAL FIELD

The present disclosure relates to an information processing system, an information processing method, and a recording medium.

### BACKGROUND ART

In recent years, the number of cases in which a vulnerability of an IT system is exploited has increased, and in order to investigate whether an exploitable vulnerability exists in a component of the IT system, it is needed to output explanation of detailed information regarding a related vulnerability from a feature of the vulnerability or information regarding software.

JP 7488976 B1 discloses a configuration of a prompt for detecting a vulnerability in a Web application and generating explanation of the detected vulnerability by a large language model (LLM). In the configuration of the prompt disclosed in a conversation processing unit of JP 7488976 B1, by searching for a vulnerability master storing detailed information regarding the vulnerability by using a vulnerability ID for identifying vulnerability information detected by the Web application as an index and by adding the detailed information regarding the vulnerability to the prompt, the detailed information regarding the vulnerability is displayed to a user. The user can easily understand a type, a risk, and the like of the detected vulnerability by referring to the displayed detailed information regarding the vulnerability.

### SUMMARY

Meanwhile, in the technology of JP 7488976 B1, it is not possible to search for information regarding a vulnerability of an object system based on ambiguous information regarding the vulnerability freely selected by a user.

An object of the present disclosure is to provide an information processing system, an information processing method, and a program that solve the problem described above.

An information processing system according to an aspect of the present disclosure includes keyword specification means for extracting a keyword related to a vulnerability of an object system included in an input sentence, vulnerability identifier specification means for specifying a vulnerability identifier that specifies the vulnerability related to the keyword, word specification means for specifying a vulnerability specification word included in a vulnerability word dictionary in association with the vulnerability identifier, and instruction information generation means for generating instruction information including the input sentence, the vulnerability specification word, and an instruction sentence instructing generation of explanation information regarding the vulnerability related to the input sentence based on the vulnerability specification word.

An information processing method according to an aspect of the present disclosure includes extracting a keyword related to a vulnerability of an object system included in an input sentence, specifying a vulnerability identifier that specifies the vulnerability related to the keyword, specifying a vulnerability specification word included in a vulnerability word dictionary in association with the vulnerability identifier, and generating instruction information including the input sentence, the vulnerability specification word, and an instruction sentence instructing generation of explanation information regarding the vulnerability related to the input sentence based on the vulnerability specification word.

A program according to an aspect of the present disclosure causes a computer to function as keyword specification means for extracting a keyword related to a vulnerability of an object system included in an input sentence, vulnerability identifier specification means for specifying a vulnerability identifier that specifies the vulnerability related to the keyword, word specification means for specifying a vulnerability specification word included in a vulnerability word dictionary in association with the vulnerability identifier, and instruction information generation means for generating instruction information including the input sentence, the vulnerability specification word, and an instruction sentence instructing generation of explanation information regarding the vulnerability related to the input sentence based on the vulnerability specification word.

### BRIEF DESCRIPTION OF THE DRAWINGS

Exemplary features and advantages of the present disclosure will become apparent from the following detailed description when taken with the accompanying drawings in which:

FIG. 1 is a diagram illustrating a configuration of an information processing device 10 according to an aspect of the present disclosure;

FIG. 2 is a hardware configuration diagram of the information processing device according to an aspect of the present disclosure;

FIG. 3 is a diagram illustrating an example of a vulnerability word dictionary according to an aspect of the present disclosure;

FIG. 4 is a first diagram illustrating a processing flow of the information processing device according to an aspect of the present disclosure;

FIG. 5 is a diagram illustrating an example of a prompt and explanation information according to an aspect of the present disclosure;

FIG. 6 is a diagram illustrating a processing outline of the information processing device according to an aspect of the present disclosure;

FIG. 7 is a second diagram illustrating functional blocks of an information processing device according to an aspect of the present disclosure;

FIG. 8 is a second diagram illustrating a processing flow of the information processing device according to an aspect of the present disclosure;

FIG. 9 is a third diagram illustrating functional blocks of an information processing device according to an aspect of the present disclosure;

FIG. 10 is a third diagram illustrating a processing flow of the information processing device according to an aspect of the present disclosure;

FIG. 11 is a diagram illustrating an example of a difference output prompt according to an aspect of the present disclosure;

FIG. 12 is a functional block diagram according to another example of the information processing system of the present disclosure; and

FIG. 13 is a diagram illustrating a processing flow according to the another example of the information processing system of the present disclosure.

### EXAMPLE EMBODIMENT

### First Example Embodiment

### Description of Configuration

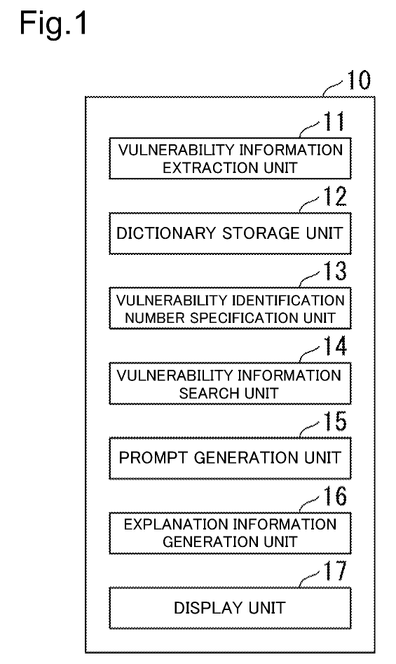

FIG. 1 is a diagram illustrating a configuration of an information processing device according to an aspect of the present disclosure.

An information processing device 10 illustrated in FIG. 1 may be a server device.

As illustrated in FIG. 1, the information processing device 10 exerts functions of a vulnerability information extraction unit 11, a dictionary storage unit 12, a vulnerability identification number specification unit 13, a vulnerability information search unit 14, a prompt generation unit 15, and an explanation information generation unit 16.

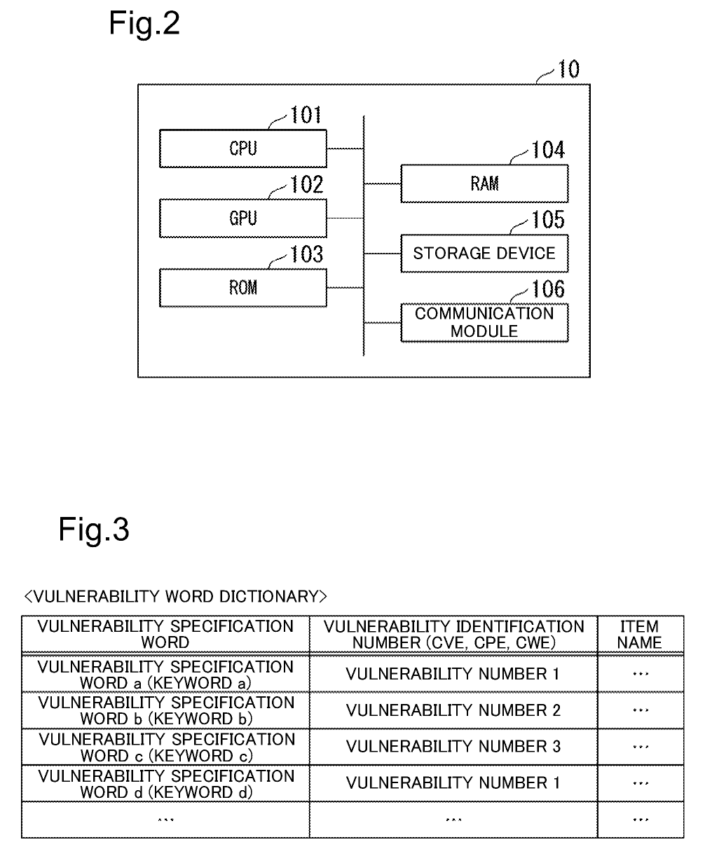

FIG. 2 is a hardware configuration diagram of the information processing device according to an aspect of the present disclosure.

As illustrated in FIG. 2, the information processing device 10 may be a computer including hardware such as a central processing unit (CPU) 101, a graphics processing unit (GPU) 102, a read only memory (ROM) 103, a random access memory (RAM) 104, a storage device 105, and a communication module 106.

By the CPU 101 of the information processing device 10 executing a program, the information processing device 10 exerts the functions of the vulnerability information extraction unit 11, the dictionary storage unit 12, the vulnerability identification number specification unit 13, the vulnerability information search unit 14, the prompt generation unit 15, the explanation information generation unit 16, and a display unit 17.

The vulnerability information extraction unit 11 extracts a vulnerability keyword included in a question sentence. The question sentence includes at least characteristics of a vulnerability of an object system or device information. The vulnerability keyword is a keyword indicating nature and a feature of the vulnerability, and may include a vendor name, a product name, a vulnerability type, severity, presence or absence of occurrence of damage, presence or absence of an attack code, and the like of a device or the like constituting the system.

Extracting the vulnerability keyword may mean extracting the vulnerability keyword included in the question sentence by keyword matching. Extracting the vulnerability keyword may also mean extracting a unique expression related to the vulnerability by a learning model and an LLM device. Alternatively, a dictionary of words indicating vulnerabilities may be used.

The dictionary storage unit 12 stores a vulnerability word dictionary that is a relation table between a vulnerability identifier and a vulnerability keyword, which is input in advance by an administrator or the like. The vulnerability identifier may be, for example, a common vulnerabilities and exposures (CVE) that uniquely specifies a vulnerability or a common platform enumeration (CPE) that uniquely identifies a device for managing vulnerability information. A common weakness enumeration (CWE) may be used as a category of the vulnerability.

The CVE is an identifier (common vulnerability identifier) for identifying security weaknesses (referred to as vulnerabilities) of various types of software. The CPE is a list (common platform list) for uniquely identifying platforms such as hardware, an operating system, and an application. The CWE is a list (common vulnerability type list) for listing types of vulnerabilities.

The vulnerability identification number specification unit 13 specifies a vulnerability identification number (vulnerability identifier) by using a vulnerability keyword extracted by the vulnerability information extraction unit 11. A method of the specification may be a keyword search using the vulnerability keyword and the vulnerability word dictionary, or may be a vector search in which each word and each vulnerability keyword in the dictionary storage unit 12 are vectorized using a trained model and then similarity is calculated, and a word and a vulnerability having high similarity are used as search results. A Euclidean distance or cosine similarity between vectors may be used as the similarity. A plurality of the vulnerability identification numbers may be specified.

The vulnerability information search unit 14 performs, by using a vulnerability identification number specified by the vulnerability identification number specification unit 13, a keyword search for the vulnerability identification number in the vulnerability word dictionary stored in the dictionary storage unit 12. Thereafter, the vulnerability information search unit 14 specifies a vulnerability specification word related to the corresponding vulnerability identification number, and outputs the specified vulnerability specification word together with the vulnerability identification number and an item name stored in the dictionary storage unit 12 in association with the vulnerability specification word. A vulnerability keyword is also one of the vulnerability specification words, and the vulnerability specification word specified from a question sentence is referred to as the vulnerability keyword for convenience of description. The vulnerability information search unit 14 specifies, from the dictionary storage unit 12, all vulnerability specification words (including the vulnerability keyword) associated with the vulnerability identification number specified from the vulnerability keyword. Therefore, the vulnerability specification word indicates each word of the words associated with the vulnerability identification number specified based on the vulnerability keyword, and is a word related to an object such as a system or a vulnerability of the object. The vulnerability specification word is a keyword indicating nature and a feature of the vulnerability, and may include a vendor name, a product name, a vulnerability type, severity, presence or absence of occurrence of damage, presence or absence of an attack code, and the like of a device or the like constituting the system. The vulnerability identification number may be a vulnerability identifier (CVE) or a common platform list (CPE). The item name stored in the dictionary storage unit 12 is detailed information regarding the vulnerability of the object related to a vulnerability identifier, and in a case where the vulnerability identifier is the CVE, the item name indicates an outline of the vulnerability, a category of the vulnerability, severity, the CPE, a CWE, or the like. In a case where the vulnerability identifier is the CPE, a type of a damaged (object) device, or a name related to the type of the damaged (object) device, such as a vendor name, a product name, and a version is indicated. An output format of the item name may be a Json format having the vulnerability identification number as a key and the item name and the vulnerability keyword as values.

The prompt generation unit 15 creates a prompt including a vulnerability identification number specified by the vulnerability identification number specification unit 13, all vulnerability specification words specified by the vulnerability information search unit 14, item names related to the vulnerability specification words, a question sentence input by a user, and an instruction sentence instructing generation of explanation information regarding a vulnerability related to the question sentence input based on the vulnerability specification words.

The explanation information generation unit 16 inputs, to an LLM, a prompt created by the prompt generation unit 15 including a vulnerability identification number, vulnerability specification words, item names related to the vulnerability specification words, a question sentence input by a user, and an instruction sentence instructing generation of explanation information regarding a vulnerability related to the question sentence input based on the vulnerability specification words, and extracts the explanation information (explanation sentence) regarding vulnerability information from output of the LLM. The display unit 17 outputs explanation information generated by the explanation information generation unit 16, and the like to a predetermined output destination.

FIG. 3 is a diagram illustrating an example of the vulnerability word dictionary according to an aspect of the present disclosure.

The vulnerability word dictionary stores a vulnerability specification word, a vulnerability identification number (vulnerability identifier), and an item name in association with one another. The vulnerability word dictionary is a dictionary data table created in advance by the administrator or the like, and may be stored in advance by the information processing device 10. A vulnerability keyword included in a question sentence input from a user is any one of the vulnerability specification words recorded in the vulnerability word dictionary. The vulnerability word dictionary may be a data table created using the vulnerability specification words specified from past question sentences.

### Description of Operation

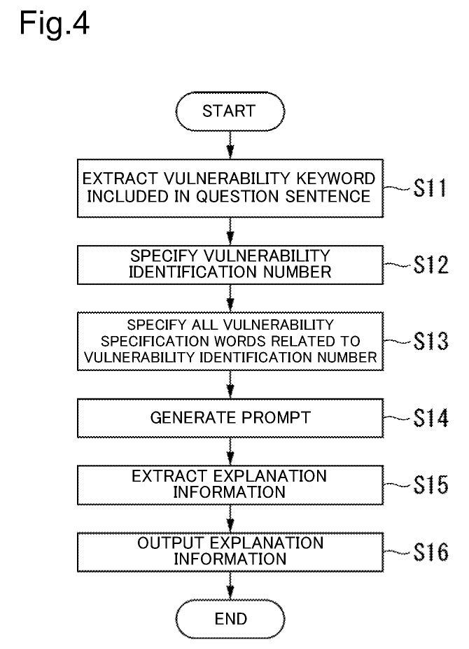

FIG. 4 is a first diagram illustrating a processing flow of the information processing device according to an aspect of the present disclosure.

Subsequently, processing of generating explanation information executed in the information processing device 10 will be described.

First, the vulnerability information extraction unit 11 extracts, from a question sentence related to existence or a feature of a vulnerability of an object system, which is input by a user, a vulnerability keyword included in the question sentence (step S11). Here, the vulnerability keyword is a term fragmentarily indicating characteristics of the vulnerability such as a type of the vulnerability, ease of exploitation, or an included device.

Next, the vulnerability identification number specification unit 13 specifies a vulnerability identification number recorded in the vulnerability word dictionary in association with the vulnerability keyword as an extraction result (step S12). Subsequently, the vulnerability information search unit 14 searches the vulnerability word dictionary of the dictionary storage unit 12 in association with the vulnerability identification number that is a specification result, and specifies all vulnerability specification words related to the vulnerability identification number (step S13).

Next, the prompt generation unit 15 generates a prompt including the question sentence, the specified vulnerability specification words, the vulnerability identification number, and an instruction sentence instructing generation of explanation information regarding the vulnerability related to the question sentence (step S14). The processing is an example of processing of generating instruction information including an input sentence, vulnerability specification words, and an instruction sentence instructing generation of explanation information regarding a vulnerability related to the input sentence based on the vulnerability specification words. The prompt generation unit 15 outputs the generated prompt to the explanation information generation unit 16. The explanation information generation unit 16 then outputs the prompt to an external LLM device. The explanation information generation unit 16 inputs output information output by the LLM device based on input of the prompt. The explanation information generation unit 16 extracts the explanation information from the output information of the LLM device (step S15). The display unit 17 outputs the explanation information extracted by the explanation information generation unit 16 to a monitor or the like as an output destination (step S16).

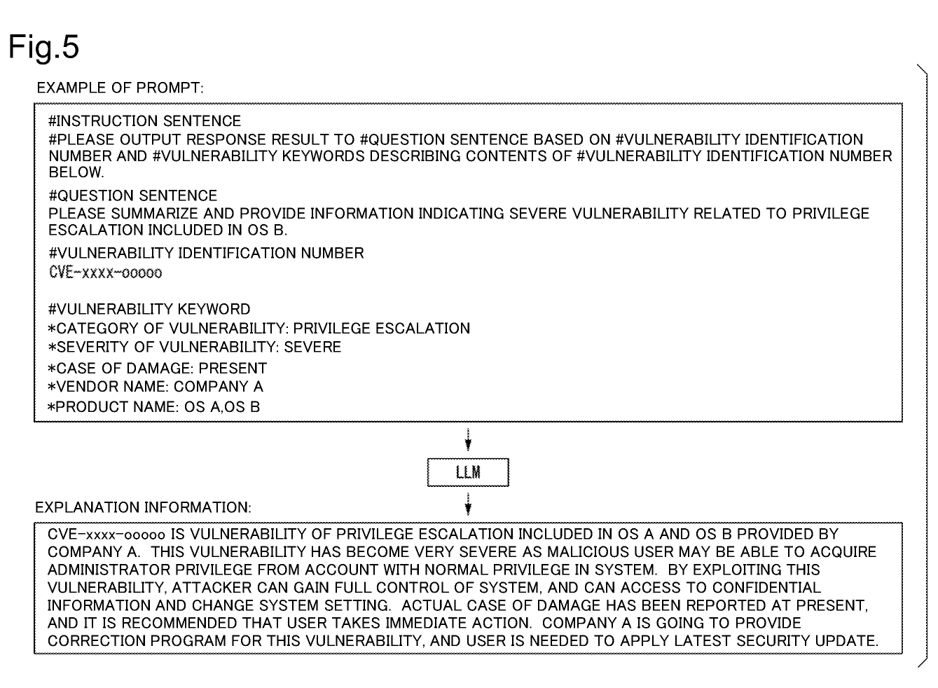

FIG. 5 is a diagram illustrating an example of a prompt and explanation information according to an aspect of the present disclosure.

It is assumed that a question sentence includes information regarding vulnerability keywords (OS_B, severe, and privilege escalation). Based on a vulnerability identification number (CVE-xxxx-ooooo) output by the vulnerability information search unit 14 based on the vulnerability keywords, the vulnerability information search unit 14 specifies, from the vulnerability word dictionary, all vulnerability specification words (OS_B, severe, privilege escalation, presence of case of damage, OS_A, and company A) related to the vulnerability identification number. Then, as illustrated in FIG. 5, the prompt generation unit 15 generates a prompt including the question sentence, the vulnerability identification number, the vulnerability specification words, and an instruction sentence (fixed form sentence). An LLM device uses this prompt as input and outputs explanation information (FIG. 5).

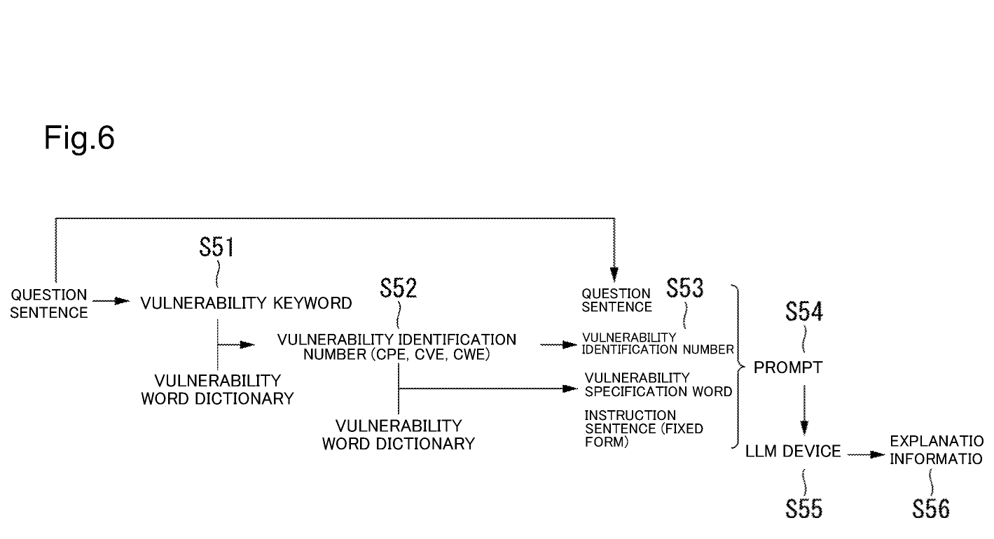

FIG. 6 is a diagram illustrating a processing outline of the information processing device according to an aspect of the present disclosure.

According to the processing described above, as illustrated in FIG. 6, the information processing device 10 specifies the vulnerability keyword from the question sentence (S51), and specifies the vulnerability identification number by using the vulnerability keyword and the vulnerability word dictionary (S52). The information processing device 10 also specifies all the vulnerability specification words by using the vulnerability identification number and the vulnerability word dictionary (S53), and generates the prompt by combining the question sentence, the vulnerability identification number, the vulnerability specification words, and the instruction sentence in a fixed form (S54). The information processing device 10 also outputs the prompt to the LLM device (S55), and generates the explanation information (S56).

### Description of Effects

Subsequently, effects of the processing of the information processing device 10 of the present disclosure will be described. As described above, the information processing device 10 specifies the vulnerability identification number from the dictionary storage unit 12 based on the vulnerability keyword included in the question sentence, and searches for the vulnerability specification words based on the specified vulnerability identification number. The information processing device 10 then generates, by using the LLM device, the explanation information by using the question sentence, the vulnerability identification number, the vulnerability specification words, and the instruction sentence for generating the explanation information in the fixed form. As a result, based on the question sentence, the information processing device 10 can generate a summary of the explanation information regarding the related vulnerability not only from the vulnerability identification number but also from the vulnerability specification words specified using the vulnerability keyword included in the question sentence. In this case, a user who desires to acquire the summary of the explanation information regarding the vulnerability can view a summary sentence that is explanation of detailed information regarding the vulnerability by using information other than the vulnerability identification number, such as software information and the category and a risk level of the vulnerability, and can efficiently acquire the detailed information regarding the vulnerability.

Here, in a related technology, there is retrieval-augmented-generation (RAG) that is a method obtained by combining the LLM and the vector search that is a method of expressing a document in a high-dimensional vector space and searching for information regarding the document by a relationship in the vector space. In the search for the information related to the document using the RAG, there are problems that accuracy is low and it is difficult to find an error in a search result because it is difficult for a user to recognize the high-dimensional vector space. On the other hand, in the processing of the information processing device 10 of the present disclosure, together with the vulnerability keyword extracted from the question sentence, all the vulnerability specification words including the keyword are searched for via the vulnerability identification number, and thus, it is possible to obtain an effect of being able to output the explanation information that is more accurate and makes it easier for a user to confirm an error of the search as compared to the method using the RAG.

### Second Example Embodiment

### Description of Configuration

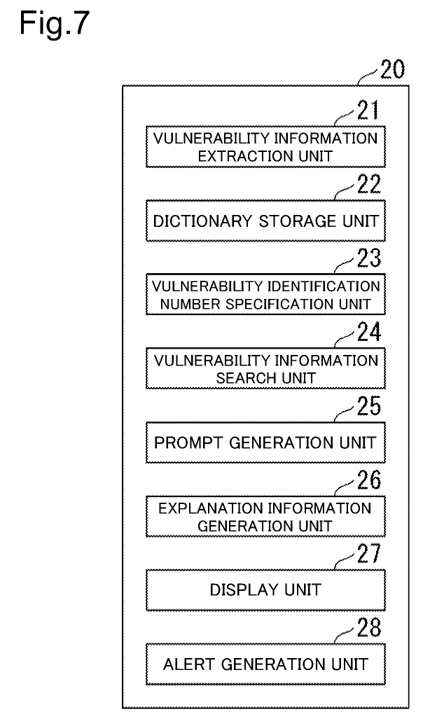

FIG. 7 is a second diagram illustrating functional blocks of an information processing device according to an aspect of the present disclosure.

Subsequently, the information processing device according to a second example embodiment will be described.

An information processing device 20 according to the second example embodiment further includes, in the information processing device 10 of FIG. 1, a function of an alert generation unit 28. A vulnerability information extraction unit 21, a dictionary storage unit 22, a vulnerability identification number specification unit 23, a vulnerability information search unit 24, a prompt generation unit 25, an explanation information generation unit 26, and a display unit 27 constituting the information processing device 20 are similar to the related functional units described with reference to the information processing device 10, and thus detailed description will be omitted.

The alert generation unit 28 outputs lack of information together with a vulnerability keyword extracted by the vulnerability information extraction unit 21 in a case where a vulnerability identification number specified by the vulnerability identification number specification unit 23 does not exist in a vulnerability word dictionary or in a case where accuracy of a specification result of the vulnerability identification number specified by the vulnerability identification number specification unit 23 is determined to be low. The case where the accuracy is low indicates, for example, a case where the number of vulnerability identification numbers specified by the vulnerability information search unit 24 by using the vulnerability keyword and the vulnerability word dictionary of the dictionary storage unit 22 is significantly large or a case where the vulnerability identification number cannot be specified. Alternatively, the case where the accuracy is low also indicates a case where a specification result of a common platform (CPE) is different from that of a related common platform (CPE) with respect to a separately specified vulnerability identifier (CVE), or a case where the specified result of the CPE is different from that of a CPE associated with a CVE specified in parallel. In general, the CVE and the CPE are associated information, and for example, CVE-xxxx-xxxxx indicates a vulnerability related to CPE:xxxxxx of software a. Therefore, in the case of a combination in which the CVE and the CPE extracted from the same question sentence are not associated with each other, a contradiction may occur in the combination of the CVE and the CPE extracted from the question sentence. Therefore, even in such a case, the alert generation unit 28 may output an alert.

### Description of Operation

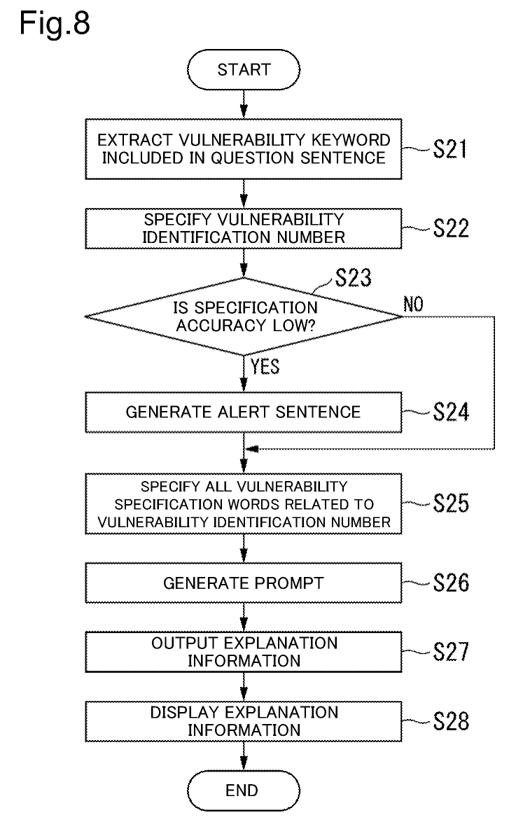

FIG. 8 is a second diagram illustrating a processing flow of the information processing device according to an aspect of the present disclosure.

Subsequently, processing of generating explanation information executed in the information processing device 20 will be described.

First, the vulnerability information extraction unit 21 extracts, from a question sentence input from the outside, a vulnerability keyword included in the question sentence (step S21). Next, the vulnerability identification number specification unit 23 specifies a vulnerability identification number recorded in the vulnerability word dictionary in association with the vulnerability keyword as an extraction result (step S22).

Subsequently, the alert generation unit 28 compares the vulnerability keyword with the specified vulnerability identification number, and determines whether specification accuracy of the vulnerability identification number is low (step S23). A case where the specification accuracy of the vulnerability identification number is low is a case where the number of vulnerability identification numbers specified using the vulnerability keyword is larger than a certain threshold, or a case where there is no vulnerability identification number associated with the vulnerability keyword. In a case where the specification accuracy of the vulnerability identification number is low, for example, the alert generation unit 28 generates, based on a determination result of the specification accuracy, an alert sentence “A large number of vulnerability identification numbers have been specified from the input question sentence” in a case where the number of the specified vulnerability identification numbers is larger than the threshold. Alternatively, in a case where the vulnerability identification number cannot be specified, the alert generation unit 28 generates an alert sentence “No vulnerability identification number has been specified”. Alternatively, the alert generation unit 28 generates an alert sentence such as “Please add a specific feature of a vulnerability to the question sentence and input the question sentence again”. In this manner, the alert generation unit 28 generates the alert sentence including that the specification accuracy of the vulnerability keyword and the vulnerability identification number is low (step S24). The display unit 27 outputs the alert sentence to a predetermined output destination.

In a case where a combination of a CVE and a CPE specified based on the question sentence is different from a combination of the CVE and the CPE stored in advance, the alert generation unit 28 may determine that the specification accuracy is low because a contradiction may occur in the combination of the CVE and the CPE. In this case, the alert generation unit 28 may generate an alert sentence such as “Since contradiction in expression related to the vulnerability occurs in the question sentence, please review the expression of the question sentence and input the question sentence again”. The display unit 27 outputs the alert sentence to a predetermined output destination.

In a case where the specification accuracy of the vulnerability keyword and the vulnerability identification number is higher than the threshold, the specified vulnerability identification number is output to the vulnerability information search unit 24. The vulnerability information search unit 24 searches the vulnerability word dictionary of the dictionary storage unit 22 in association with the vulnerability identification number that is a specification result, and specifies all vulnerability specification words related to the vulnerability identification number (step S25).

Next, the prompt generation unit 25 generates a prompt including the question sentence, the specified vulnerability specification words, the vulnerability identification number, and an instruction sentence instructing generation of explanation information regarding the vulnerability related to the question sentence (step S26). The prompt generation unit 25 outputs the generated prompt to the explanation information generation unit 26. The explanation information generation unit 26 then outputs the prompt to an LLM device. The explanation information generation unit 26 inputs output information output by the LLM device based on input of the prompt. The explanation information generation unit 26 extracts the explanation information from the output information of the LLM device (step S27). The display unit 27 outputs the explanation information extracted by the explanation information generation unit 26 to an output destination such as the display unit (step S28).

### Description of Effects

Subsequently, effects of the processing of the information processing device 20 of the present disclosure will be described. As described above, the information processing device 20 includes the alert generation unit 28 as compared with the information processing device 10, and the vulnerability identification number specification unit 23 evaluates the specification accuracy of the specified vulnerability identification number from consistency between the plurality of vulnerability identification numbers and the vulnerability keyword. Then, in a case where the specification accuracy is low, the alert generation unit 28 displays the vulnerability keyword extracted from the question sentence and the sentence representing that the accuracy is low, and the user views the sentence output by the alert generation unit 28 and reviews, again, the question sentence in which the vulnerability identification number can be specified, and inputs the question sentence to the information processing device 20, in such a way that accuracy of a summary sentence of vulnerability information can be improved. As a result, the user can efficiently acquire the explanation information regarding the vulnerability of the desired object system.

### Third Example Embodiment

### Description of Configuration

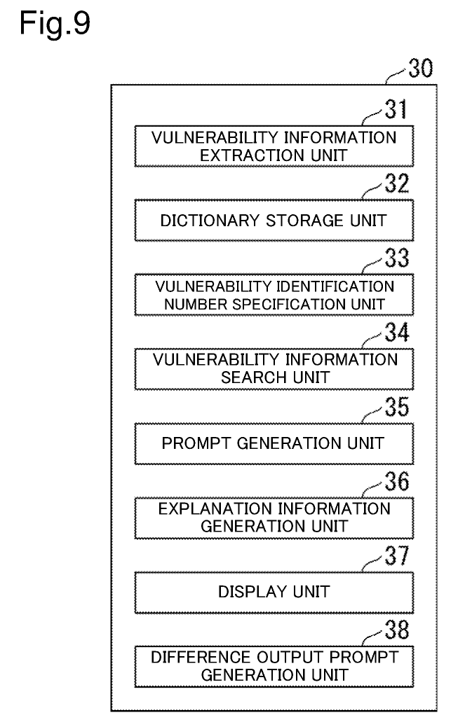

FIG. 9 is a third diagram illustrating functional blocks of an information processing device according to an aspect of the present disclosure.

Subsequently, the information processing device according to a third example embodiment will be described.

An information processing device 30 is different from the information processing device 10 in FIG. 1 in that a function of a difference output prompt generation unit 38 is added. A vulnerability information extraction unit 31, a dictionary storage unit 32, a vulnerability identification number specification unit 33, a vulnerability information search unit 34, a prompt generation unit 35, an explanation information generation unit 36, and a display unit 37 constituting the information processing device 30 are similar to the related functional units described with reference to the information processing device 10, and thus detailed description will be omitted.

The difference output prompt generation unit 38 generates, in a case where there is a plurality of vulnerability identification numbers specified by the vulnerability identification number specification unit 33, a difference output prompt (second instruction sentence) including the plurality of vulnerability identification numbers and an instruction sentence instructing to output a difference in vulnerabilities indicated by the vulnerability identification numbers.

### Description of Operation

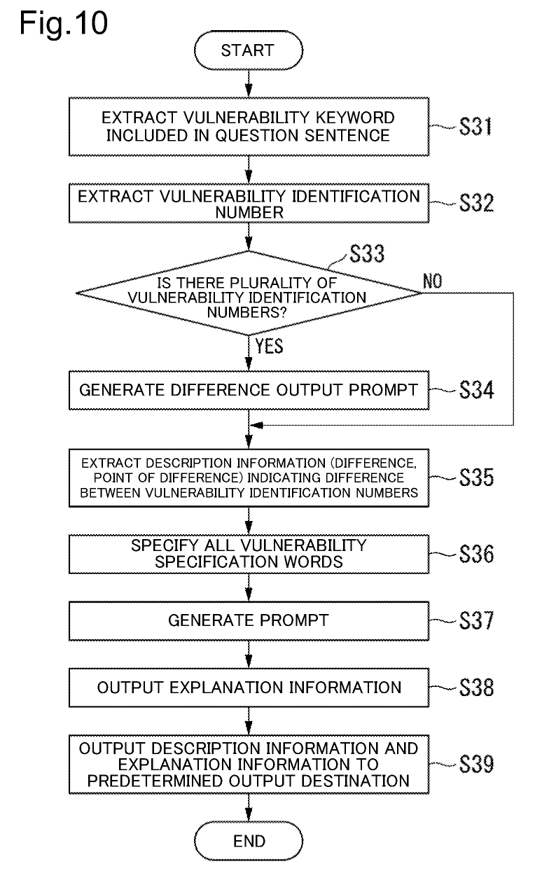

FIG. 10 is a third diagram illustrating a processing flow of the information processing device according to an aspect of the present disclosure.

Subsequently, processing of generating explanation information executed in the information processing device 30 will be described.

First, the vulnerability information extraction unit 31 extracts, from a question sentence input from the outside, a vulnerability keyword included in the question sentence (step S31). Next, the vulnerability identification number specification unit 33 specifies a vulnerability identification number recorded in a vulnerability word dictionary in association with the vulnerability keyword as an extraction result (step S32).

Subsequently, the difference output prompt generation unit 38 determines whether there is a plurality of the specified vulnerability identification numbers (step S33). In a case where there is the plurality of specified vulnerability identification numbers, the difference output prompt generation unit 38 generates a difference output prompt including the vulnerability identification numbers and an instruction sentence instructing to output a difference (difference) in vulnerabilities related to the vulnerability identification numbers (step S34).

Next, the difference output prompt generation unit 38 outputs the generated difference output prompt to the explanation information generation unit 36. The explanation information generation unit 36 outputs the prompt generated by the difference output prompt generation unit 38 to an LLM device. The explanation information generation unit 36 extracts, from output of the LLM device, description information (difference, point of difference) indicating the difference between the plurality of vulnerability identification numbers (step S35).

In addition to this processing, regardless of the number of vulnerability identification numbers specified in step S33, the vulnerability information extraction unit 31 outputs the vulnerability identification numbers to the vulnerability information search unit 34. The vulnerability information search unit 34 searches the vulnerability word dictionary of the dictionary storage unit 32 in association with the vulnerability identification numbers that are extraction results, and specifies all vulnerability specification words related to the vulnerability identification numbers (step S36).

The prompt generation unit 35 then generates a prompt including the question sentence, the specified vulnerability specification words, the vulnerability identification numbers, and an instruction sentence instructing generation of explanation information regarding the vulnerability related to the question sentence (step S37). The explanation information generation unit 36 then outputs the prompt to the LLM device. The explanation information generation unit 36 inputs output information output by the LLM device based on input of the prompt. The explanation information generation unit 36 outputs the explanation information from the output information (step S38).

The display unit 37 acquires the description information describing the difference between the plurality of vulnerability identification numbers included in the output information generated by the LLM device based on the difference output prompt generated by the difference output prompt generation unit 38, and the explanation information extracted from the output information generated by the LLM device based on the prompt generated by the prompt generation unit 35. The display unit 37 outputs the description information and the explanation information to a predetermined output destination (step S39).

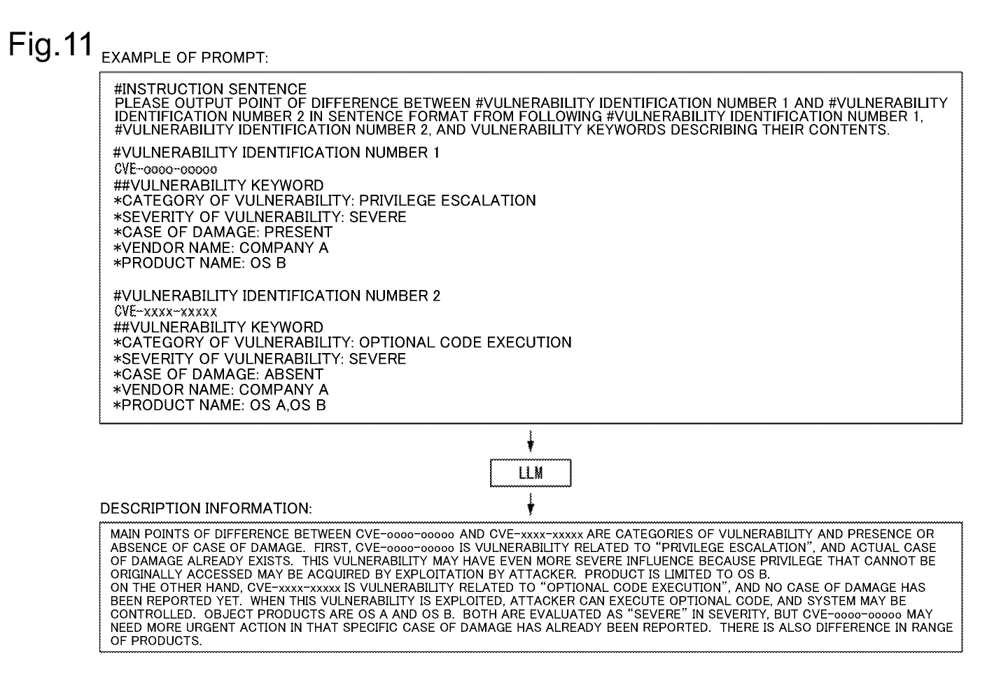

FIG. 11 is a diagram illustrating an example of a prompt generated by the difference output prompt generation unit 38.

An example of the prompt illustrated in FIG. 11 includes information regarding the prompt in which a plurality of specified vulnerability identification numbers (CVE-oooo-ooooo and CVE-xxxx-xxxxx) is described, and which includes description information (CVE-oooo-ooooo: privilege escalation, severe, presence of case of damage, company A, and OS_B/CVE-xxxx-xxxxx: optional code execution, severe, absence of case of damage, OS_A, and OS_B) regarding a difference in vulnerabilities related to the plurality of vulnerability identification numbers, and a sentence instructing output of the difference between the vulnerability identification numbers. The LLM device uses such a prompt as input and generates output information indicating the description information regarding the difference in vulnerabilities related to the plurality of vulnerability identification numbers.

### Description of Effects

Subsequently, effects of the present example embodiment will be described. As described above, the information processing device 30 includes the difference output prompt generation unit 38 as compared with the information processing device 10, and has the function of outputting, in a case where there is the plurality of vulnerability identification numbers specified by the vulnerability identification number specification unit 33, the difference (difference) in meanings of the vulnerabilities related to the vulnerability identification numbers. As a result, even when inputting an ambiguous question sentence, a user can grasp specified candidates for the vulnerability identification number and a point of difference therebetween, and when executing the information processing device 30 again, the user can more efficiently acquire detailed information regarding the vulnerability by inputting the next question sentence that further takes into account the difference, or the like.

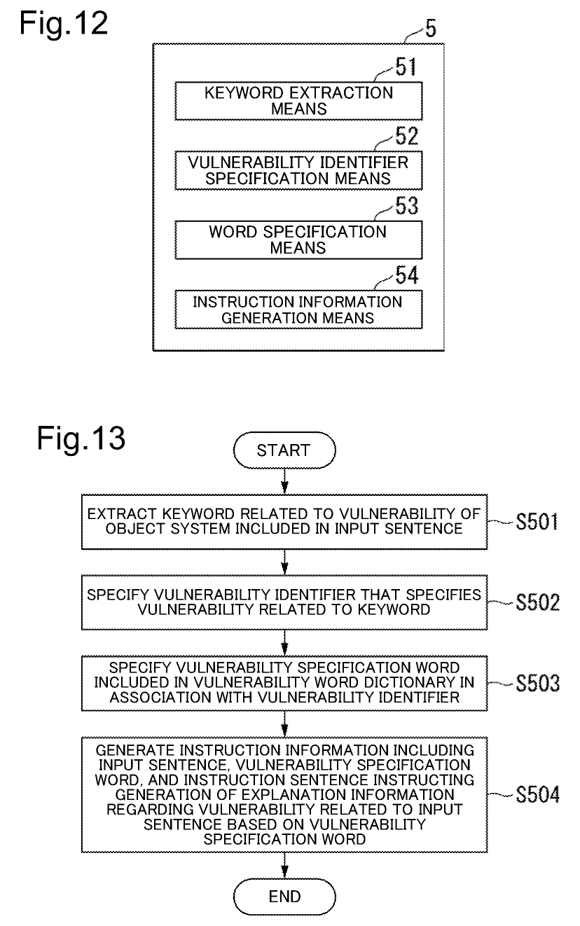

FIG. 12 is a functional block diagram according to another example of the information processing device of the present disclosure.

FIG. 13 is diagram illustrating a processing flow according to the another example of the information processing device of the present disclosure.

As another example, the information processing device may include keyword extraction means 51, vulnerability identifier specification means 52, word specification means 53, and instruction information generation means 54.

The keyword extraction means 51 extracts a keyword related to a vulnerability of an object system included in an input sentence (step S501).

The vulnerability identifier specification means 52 specifies a vulnerability identifier that specifies the vulnerability related to the keyword (step S502).

The word specification means 53 specifies a vulnerability specification word included in a vulnerability word dictionary in association with the vulnerability identifier (step S503).

The instruction information generation means 54 generates instruction information including the input sentence, the vulnerability specification word, and an instruction sentence instructing generation of explanation information regarding the vulnerability related to the input sentence based on the vulnerability specification word (step S504).

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims.

Some or all of the above-described example embodiments may be described as the following Supplementary Notes, but are not limited thereto.

### Supplementary Note 1

An information processing system including:

keyword specification means for extracting a keyword related to a vulnerability of an object system included in an input sentence;

vulnerability identifier specification means for specifying a vulnerability identifier that specifies the vulnerability related to the keyword;

word specification means for specifying a vulnerability specification word included in a vulnerability word dictionary in association with the vulnerability identifier; and

instruction information generation means for generating instruction information including the input sentence, the vulnerability specification word, and an instruction sentence instructing generation of explanation information regarding the vulnerability related to the input sentence based on the vulnerability specification word.

### Supplementary Note 2

The information processing system according to Supplementary Note 1, further including

generation means for generating the explanation information based on the instruction sentence.

### Supplementary Note 3

The information processing system according to Supplementary Note 2, in which

the generation means outputs the instruction sentence to a large-scale language model device and generates the explanation information.

### Supplementary Note 4

The information processing system according to any one of Supplementary Notes 1 to 3, in which

the input sentence is information including nature and a feature of the vulnerability, and

the keyword specification means specifies, as the keyword related to the vulnerability, a keyword including the nature and the feature of the vulnerability included in the input sentence.

### Supplementary Note 5

The information processing system according to any one of Supplementary Notes 1 to 4, further including

alert generation means for generating, in a case where a plurality of the vulnerability identifiers specifying the vulnerability related to the keyword is specified, an alert based on specification accuracy of the plurality of vulnerability identifiers.

### Supplementary Note 6

The information processing system according to any one of Supplementary Notes 1 to 5, further including

difference instruction information generation means for generating a second instruction sentence instructing generation of description information indicating a difference in the vulnerability indicated by the vulnerability identifier that specifies the vulnerability related to the keyword.

### Supplementary Note 7

The information processing system according to any one of Supplementary Notes 1 to 6, in which

the vulnerability identifier is an identifier of a common vulnerabilities and exposures (CVE) that specifies a known security risk that is disclosed.

### Supplementary Note 8

The information processing system according to any one of Supplementary Notes 1 to 7, in which

the vulnerability identifier is an identifier of a common platform enumeration (CPE) that specifies the object.

### Supplementary Note 9

The information processing system according to any one of Supplementary Notes 1 to 8, in which

the vulnerability identifier is an identifier of a common weakness enumeration (CWE) that specifies classification of the vulnerability related to security of the object.

### Supplementary Note 10

An information processing method including:

extracting a keyword related to a vulnerability of an object system included in an input sentence;

specifying a vulnerability identifier that specifies the vulnerability related to the keyword;

specifying a vulnerability specification word included in a vulnerability word dictionary in association with the vulnerability identifier; and

generating instruction information including the input sentence, the vulnerability specification word, and an instruction sentence instructing generation of explanation information regarding the vulnerability related to the input sentence based on the vulnerability specification word.

### Supplementary Note 11

The information processing method according to Supplementary Note 10, further including

generation means for generating the explanation information based on the instruction sentence.

### Supplementary Note 12

The information processing method according to Supplementary Note 11, in which

the generation means outputs the instruction sentence to a large-scale language model device and generates the explanation information.

### Supplementary Note 13

The information processing method according to Supplementary Note 12, in which

the input sentence is information including nature and a feature of the vulnerability, and

the keyword specification means specifies, as the keyword related to the vulnerability, a keyword including the nature and the feature of the vulnerability included in the input sentence.

### Supplementary Note 14

The information processing method according to any one of Supplementary Notes 10 to 13, further including

alert generation means for generating, in a case where a plurality of the vulnerability identifiers specifying the vulnerability related to the keyword is specified, an alert based on specification accuracy of the plurality of vulnerability identifiers.

### Supplementary Note 15

The information processing method according to any one of Supplementary Notes 10 to 14, further including

difference instruction information generation means for generating a second instruction sentence instructing generation of description information indicating a difference in the vulnerability indicated by the vulnerability identifier that specifies the vulnerability related to the keyword.

### Supplementary Note 16

The information processing method according to any one of Supplementary Notes 10 to 15, in which

the vulnerability identifier is an identifier of a common vulnerabilities and exposures (CVE) that specifies a known security risk that is disclosed.

### Supplementary Note 17

The information processing method according to any one of Supplementary Notes 10 to 16, in which

the vulnerability identifier is an identifier of a common platform enumeration (CPE) that specifies the object.

### Supplementary Note 18

The information processing method according to any one of Supplementary Notes 10 to 17, in which

the vulnerability identifier is an identifier of a common weakness enumeration (CWE) that specifies classification of the vulnerability related to security of the object.

### Supplementary Note 19

A program for causing a computer to function as:

keyword specification means for extracting a keyword related to a vulnerability of an object system included in an input sentence;

vulnerability identifier specification means for specifying a vulnerability identifier that specifies the vulnerability related to the keyword;

word specification means for specifying a vulnerability specification word included in a vulnerability word dictionary in association with the vulnerability identifier; and

instruction information generation means for generating instruction information including the input sentence, the vulnerability specification word, and an instruction sentence instructing generation of explanation information regarding the vulnerability related to the input sentence based on the vulnerability specification word.

### Supplementary Note 20

The program according to Supplementary Note 19, further causing the computer to function as

generation means for generating the explanation information based on the instruction sentence.

### Supplementary Note 21

The program according to Supplementary Note 20, in which

the generation means outputs the instruction sentence to a large-scale language model device and generates the explanation information.

### Supplementary Note 22

The program according to Supplementary Note 21, in which

the input sentence is information including nature and a feature of the vulnerability, and

the keyword specification means specifies, as the keyword related to the vulnerability, a keyword including the nature and the feature of the vulnerability included in the input sentence.

### Supplementary Note 23

The program according to any one of Supplementary Notes 19 to 22, further causing the computer to function as

alert generation means for generating, in a case where a plurality of the vulnerability identifiers specifying the vulnerability related to the keyword is specified, an alert based on specification accuracy of the plurality of vulnerability identifiers.

### Supplementary Note 24

The program according to any one of Supplementary Notes 19 to 23, further causing the computer to function as

difference instruction information generation means for generating a second instruction sentence instructing generation of description information indicating a difference in the vulnerability indicated by the vulnerability identifier that specifies the vulnerability related to the keyword.

### Supplementary Note 25

The program according to any one of Supplementary Notes 19 to 24, in which

the vulnerability identifier is an identifier of a common vulnerabilities and exposures (CVE) that specifies a known security risk that is disclosed.

### Supplementary Note 26

The program according to any one of Supplementary Notes 19 to 25, in which

the vulnerability identifier is an identifier of a common platform enumeration (CPE) that specifies the object.

### Supplementary Note 27

The program according to any one of Supplementary Notes 19 to 26, in which

the vulnerability identifier is an identifier of a common weakness enumeration (CWE) that specifies classification of the vulnerability related to security of the object.

According to the present disclosure, the present disclosure can be applied to applications such as an information search device that searches for corresponding vulnerability information from information regarding an ambiguous vulnerability, and a program for achieving the information search device in a computer. The function of searching for the corresponding vulnerability information from the information regarding the ambiguous vulnerability can also be applied to an application such as external information reference means of a chatbot related to security by an LLM device.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. An information processing system comprising:
at least one memory storing instructions; and
at least one processor configured to execute the instructions to:
extract a keyword related to a vulnerability of an object system included in an input sentence;
specify a vulnerability identifier that specifies the vulnerability related to the keyword;
specify a vulnerability specification word included in a vulnerability word dictionary in association with the vulnerability identifier; and
generate instruction information including the input sentence, the vulnerability specification word, and an instruction sentence instructing generation of explanation information regarding the vulnerability related to the input sentence based on the vulnerability specification word.

2. The information processing system according to claim 1,
wherein the at least one processor is further configured to execute the instructions to:
generate the explanation information based on the instruction sentence.

3. The information processing system according to claim 2,
wherein the at least one processor is further configured to execute the instructions to:
generate the explanation information by outputting the instruction sentence to a large-scale language model device.

4. The information processing system according to claim 3,
wherein the at least one processor is further configured to execute the instructions to:
specify, as the keyword related to the vulnerability, a keyword including the nature and the feature of the vulnerability included in the input sentence, the input sentence being information including nature and a feature of the vulnerability.

5. The information processing system according to claim 1,
wherein the at least one processor is further configured to execute the instructions to:
generate, in a case where a plurality of the vulnerability identifiers specifying the vulnerability related to the keyword is specified, an alert based on specification accuracy of the plurality of vulnerability identifiers.

6. The information processing system according to claim 1,
wherein the at least one processor is further configured to execute the instructions to:
generate a second instruction sentence instructing generation of description information indicating a
difference in the vulnerability indicated by the vulnerability identifier that specifies the vulnerability related to the keyword.

7. The information processing system according to claim 1, wherein
the vulnerability identifier is an identifier of a common vulnerabilities and exposures (CVE) that specifies a known security risk that is disclosed.

8. The information processing system according to claim 1, wherein
the vulnerability identifier is an identifier of a common platform enumeration (CPE) that specifies the object.

9. The information processing system according to claim 1, wherein
the vulnerability identifier is an identifier of a common weakness enumeration (CWE) that specifies classification of the vulnerability related to security of the object.

10. An information processing method comprising:
by a computer,
extracting a keyword related to a vulnerability of an object system included in an input sentence;
specifying a vulnerability identifier that specifies the vulnerability related to the keyword;
specifying a vulnerability specification word included in a vulnerability word dictionary in association with the vulnerability identifier; and
generating instruction information including the input sentence, the vulnerability specification word, and an instruction sentence instructing generation of explanation information regarding the vulnerability related to the input sentence based on the vulnerability specification word.

11. A non-transitory recording medium recording a program for causing a computer to execute the processing of:
extracting a keyword related to a vulnerability of an object system included in an input sentence;
specifying a vulnerability identifier that specifies the vulnerability related to the keyword;
specifying a vulnerability specification word included in a vulnerability word dictionary in association with the vulnerability identifier; and
generating instruction information including the input sentence, the vulnerability specification word, and an instruction sentence instructing generation of explanation information regarding the vulnerability related to the input sentence based on the vulnerability specification word.
